(19) United States
(12) Patent Application Publication
(10) Pub. No.: US 2005/0172941 A1
(43) Pub. Date: Aug. 11, 2005

(54) Direct injection diesel engine, with catalytic combustion in the combustion chamber

(76) Inventors: Vladimir Torgov, Orbassamo Torino (IT); Piero Perlo, Sommariva Bosco (IT)

Correspondence Address: SUGHRUE MION, PLLC, 2100 PENNSYLVANIA AVENUE, N.W., SUITE 800, WASHINGTON, DC, 20037, US

(21) Appl. No.: 10/515,914

(22) PCT Filed: Dec. 23, 2003
(86) PCT No.: PCT/IB03/06264

(30) Foreign Application Priority Data
Jan. 31, 2003 (IT) TO2003A000059

(51) Int. Cl. F02G 5/00; F02B 51/02

(52) U.S. Cl. 123/670; 123/543

(57) ABSTRACT

A direct injection Diesel engine is provided with a support (8) coated with a catalyser material which occupies at least a part of the space within the cylinder (1), to promote a catalytic combustion and reduce harmful exhaust gases.

The present invention relates to Diesel engines and in particular to Diesel engines with direct injection.

In order to improve combustion and reduce harmful exhaust gases, it has already been proposed to achieve a catalytic combustion in the combustion chamber, providing a catalyser over a ceramic support. The document EP 1 132 592 A2, for example, generically proposes providing a coating of the combustion chamber or pre-chamber of a Diesel engine, constituted by small quantities of metals able to serve as catalysers over a ceramic substrate, thereby promoting a catalytic combustion reaction. Said document does not disclose a specific embodiment solution, but it does mention, with reference to the case of a Diesel engine provided with combustion pre-chamber, the provision of a ceramic layer on the wall of the pre-chamber and its coating with small quantities of rhodium, platinum and palladium, alone or in alloy, possibly accompanied by other metals serving a similar catalyser function, such as copper, silver, aluminium, manganese, zinc, etcetera.

The document U.S. Pat. No. 4,715,347 discloses an engine with a catalytic combustion pre-chamber, in which is provided a catalyser bed constituted by a layering of different catalytic materials, for example layers of alumina covered with platinum alternated with layers of magnesium oxide.

The document U.S. Pat. No. 4,245,589 discloses a gasoline engine in which, to improve efficiency, each injector is provided with an adapter comprising a ceramic body covered with a catalyser which is electrically pre-heated to its level of exothermic activity and which serves as a deflector of the jet of gasoline exiting the injector, thereby heating said jet.

It has also been proposed to provide a catalyser layer on the surface of the heating section of a pre-heating plug in a Diesel engine (see document JP-A-59 167 6359). A solution of Diesel engine with combustion pre-chamber coated with a catalyser layer is also proposed in the document JP-A-4 347 329.

Although the general principle of achieving a catalytic combustion in the combustion chamber of a Diesel engine has already been proposed, none of the prior art solutions described above is nonetheless capable of achieving an efficient catalytic combustion inside the combustion chamber, to obtain a practical reduction of harmful exhaust gases.

In view of achieving the aforesaid aim, the present invention relates to a Diesel engine, comprising at least a cylinder, a piston able to slide in the cylinder, a combustion chamber associated with the cylinder, injector means to inject fuel into the combustion chamber, and means for promoting a catalytic combustion of the fuel in the combustion chamber, characterised in that said means for promoting catalytic combustion comprise a support covered with a catalyser, and positioned in such a way as to occupy at least in part the internal space of the combustion chamber.

In an embodiment, said support can be, for example, in the form of a disc positioned coaxially to the cylinder and occupying the entire cross section of the cylinder.

In a first example, said disc has a plurality of through holes destined to receive corresponding axial projections formed on the crown of the piston when the piston arrives in proximity to the Top Dead Centre. In a second example, the aforesaid disc serving as a support for the catalyser has no through opening, but solely cavities provided on its lower surface to receive corresponding axial projections formed on the crown of the piston.

In this case or in both, the material of the disc can be sufficiently porous to allow the gases to pass through it. The structure of the disc can be a honeycomb structure and it can be constructed starting from metals and/or alloys with high melting point, or from ceramic and/or metallic-ceramic materials. The catalyser can be constituted by quantities of one or more of the metals generally used for this purpose.

To improve the result, the upper surface of the piston can also be covered with a catalyser, in particular on the surface of the axial projections that are received within the openings of the disc bearing the catalyser.

In a second embodiment, the support of the catalyser can be constituted by one or more elastic means interposed between the crown of the piston and the top surface of the cylinder, said elastic means being covered with the catalyser.

As stated above, one or more of the known metals having this property can be used as catalysers. In a specific embodiment, the aforesaid elastic means are in the form of helical springs having their opposite ends connected respectively to the piston and to the top surface of the cylinder. These springs can also be constituted by metals or alloys with high melting point or by ceramic and/or metallic-ceramic materials. More specifically, the opposite ends of the springs are directly connected to support elements which in turn are fastened respectively to the piston and to the head of the cylinder. The element fastened to the head of the cylinder naturally has the necessary openings to avoid interfering with the operation of the intake and exhaust valve and of the injector.

Instead of a single catalyser, it is also possible to provide a layering of different catalysers. Moreover, in the case of the first embodiment, the shape and the arrangement of the openings obtained in the catalyser support disc may be any.

Further features and advantages of the invention shall become readily apparent from the description that follows with reference to the accompanying drawings, provided purely by way of non limiting example, in which:

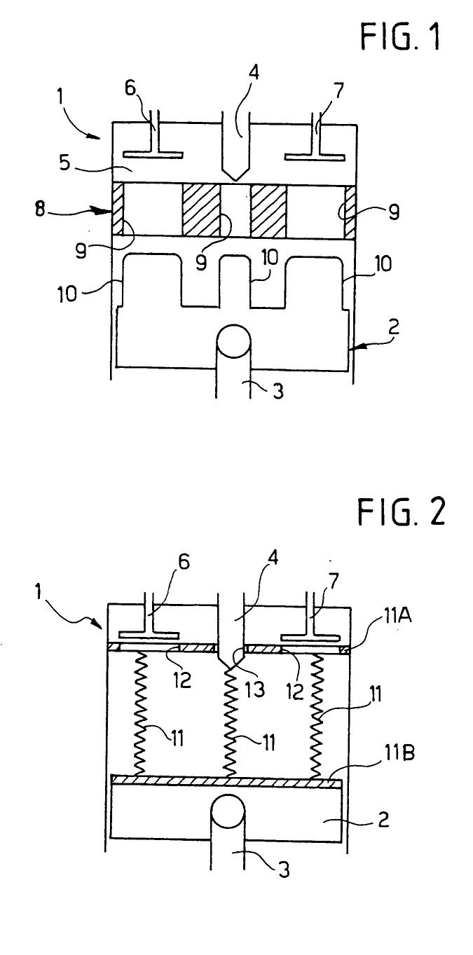

FIG. 1 is a schematic section view of the cylinder of a Diesel engine according to a first embodiment of the invention, and

FIG. 2 shows a variant of FIG. 1, corresponding to a second embodiment of the invention.

In the accompanying drawings, the number 1 globally designates a cylinder of a Diesel engine with direct injection, in which is mounted in sliding fashion a piston 2 associated to a piston rod 3 (shown only partially). To the cylinder 1 is associated an injector 4 of any kind known in itself, which injects the fuel directly into the combustion chamber 5, defined between the top of the cylinder and the crown of the piston 2.

FIG. 1 shows the piston in an intermediate position, distanced from the Top Dead Centre. The reference numbers 6, 7 respectively designate an intake valve and an exhaust valve associated with the cylinder. The drawing does not show the intake conduit, or the exhaust conduit, or the constructive details of the different components mentioned above, since they can be constructed in any known manner. Moreover, elimination of said details from the drawings make the drawings themselves more readily and easily understandable.

According to the invention, the space inside the cylinder 1, adjacent to its top, is occupied by a disc 8 having a honeycomb structure, constituted by a metal and/or alloy with high melting point, or by a ceramic material, or by a metallic-ceramic material and coated with one or more layers of one or more catalysers selected among the usual metals employed in the art for this purposes. In the illustrated example, the disc 8 has a plurality of through openings 9 which receive corresponding axial projections 10 formed on the crown of the piston 2 when the piston arrives in proximity to its top dead centre.

As stated above, the through openings 9 can be arranged in any way at all. Moreover, a variant can be provided in which the openings 9 are not through, but rather constitute cavities obtained on the lower surface of the disc 8, destined to receive complementary projections 10 formed by the crown of the piston in correspondence with the top dead centre position. In this case, as may also occur in the previous case, the honeycomb structure may have sufficient porosity to allow the passage through it of air during the intake phase and of the combustion gases during the exhaust phase. Naturally, the disc 8 is mounted at an adequate distance from the top of the cylinder in order not to interfere with the correct operation of the valves 6, 7 of the injector 4. To improve catalytic combustion, preferably the piston crown is to be covered with one or more catalyser layers, at least in correspondence with the axial projections 10.

In operation, during the intake phase, the piston moves downwards and the air that enters the cylinder through the intake valve 6 flows in the lower part of the cylinder through the openings 9 of the disc 8. At the end of the subsequent compression phase, when the piston is near the Top Dead Centre, the injector 4 injects the fuel into the combustion chamber and a catalytic combustion thereby starts in proximity to the honeycomb structure of the disc 8 with propagation on the axial projections 10 of the piston. During the subsequent exhaust phase, the exhaust gases are forced to flow back through the honeycomb structure, with a continuation of the catalytic combustion and a consequent drastic reduction in harmful exhaust gases.

FIG. 2 shows the second embodiment of the invention, which differs in that in this case the support of the catalyser material is constituted by one or more helical springs 11 which can be made of the same materials used for the disc 8 of FIG. 1 and covered with one or more layers of catalyser. The opposite ends of the springs 11 are connected to support discs 11A, 11B respectively fastened to the top of the cylinder and to the crown of the piston 2. Naturally, the example illustrates the case of springs 11 in the form of helical springs, but any other spring conformation and arrangement is possible. The support disc 11A has holes 12, 13 for the passage of the fluid during the intake and the exhaust phases and for mounting the injector 4.

In the case of the variant of FIG. 2, when the piston is near its Top Dead Centre, the springs 11 are in their minimum length configuration and, not remaining aligned with the axis of the cylinder, they position themselves at random, occupying nearly the entire combustion chamber. With the injection of fuel by the injector 4, catalytic combustion starts with no flame and with low production of harmful gases. Lastly, during the exhaust phase, the springs are compressed by the piston, which produces a continuation of the catalytic combustion and a further reduction in harmful exhaust gases.

Naturally, without altering the principle of the invention, the construction details and the embodiment may vary widely from what is described and illustrated purely by way of example herein.

1. A diesel engine, comprising:
at least one cylinders,
a piston mounted in sliding fashion in the cylinders,
a combustion chamber associated with the cylinder,
injector means for injecting fuel into the combustion chamber means for promoting a catalytic combustion in the combustion chamber,
wherein said means for promoting the catalytic combustion comprise a support covered with a catalyser and positioned in such a way as to occupy at least a part of the internal space of the combustion chamber.

2. A diesel engine as claimed in claim 1, wherein said support is a disc positioned coaxially to the cylinder and occupying the entire cross section of the cylinder.

3. A diesel engine as claimed in claim 1, wherein said disc has a honeycomb structure.

4. A diesel engine as claimed in claim 2, wherein said disc is constituted by a material selected among metals with high melting point and/or their alloys, ceramic materials, metallic-ceramic materials.

5. A diesel engine as claimed in claim 2, wherein said disc has through openings to receive corresponding axial projections formed on the crown of the piston when the piston arrives in proximity to its top dead centre.

6. A diesel engine as claimed in claim 2, wherein said disc has on its lower surface cavities destined to receive axial projections formed on the crown of the piston when the piston arrives in proximity to its top dead centre.

7. A diesel engine as claimed in claim 5, wherein the crown of the piston is covered with a catalyser, at least in correspondence with said axial projections.

8. A diesel engine as claimed in claim 1, wherein the catalyser is selected among rhodium, platinum, palladium and their alloys, possibly with the addition of other metals having catalytic functions such as copper, silver, aluminium, manganese, zinc.

9. A diesel engine as claimed in claim 1, wherein there are multiple layers of different catalysers.

10. A diesel engine as claimed in claim 1 wherein said support is constituted by elastic means interposed between the top of the cylinder and the piston.

11. A diesel engine as claimed in claim 10, wherein said elastic means are constituted by one or more helical springs whose ends are connected respectively to the top of the cylinder and to the piston.

12. A diesel engine as claimed in claim 11, wherein the opposite ends of said helical springs are respectively connected to support discs which in turn are fastened to the top of the cylinder and to the piston.

13. A diesel engine as claimed in claim 12, wherein said support disc, fastened to the top of the cylinder has openings in correspondence with the intake and exhaust valves and with the injector associated with the cylinder.

14. A diesel engine as claimed in claim 12, wherein said springs are made of a material selected among: metals with high melting point or alloys thereof, ceramic materials, metallic-ceramic materials.
